(19) United States
(12) Patent Application Publication
(10) Pub. No.: US 2021/0017987 A1
(43) Pub. Date: Jan. 21, 2021

(54) SYSTEMS AND METHODS FOR ENHANCED COMPRESSOR BEARING LIFE

(71) Applicant: Johnson Controls Technology Company, Auburn Hills, MI (US)

(72) Inventors: Tianshi Wu, St. Francis, WI (US); David Eugene Eaton, II, Waynesboro, PA (US); Holger Tychsen, Waynesboro, PA (US); Bruce Lee Griffith, Greencastle, PA (US); John Lloyd Neel, Fairfield, PA (US)

(21) Appl. No.: 16/982,971

(22) PCT Filed: Mar. 20, 2019
(86) PCT No.: PCT/US2019/023233

§ 371 Date: Sep. 21, 2020

Related U.S. Application Data
(60) Provisional application No. 62/646,226, filed on Mar. 21, 2018.

(51) Int. Cl. F04C 18/16; F04C 29/00

(52) U.S. Cl. CPC F04C 18/16; F04C 28/12; F04C 29/0021

(57) ABSTRACT

The present disclosure relates to a bearing load control system that includes a force application device configured to apply a force to a bearing of a compressor and a sensor configured to provide feedback indicative of an operating parameter of the compressor. The bearing load control system also includes a controller that is communicatively coupled to the sensor and configured to determine an indication of a thrust force applied to the bearing based on the feedback indicative of the operating parameter. The controller is also configured to adjust the force application device to control the force applied to the bearing based at least in part on a control algorithm and the indication of the thrust force.

### CROSS-REFERENCE TO RELATED APPLICATIONS

This application claims priority to and the benefit of U.S. Provisional Application Ser. No. 62/646,226, entitled “SYSTEMS AND METHODS FOR ENHANCED COMPRESSOR BEARING LIFE,” filed Mar. 21, 2018, which is herein incorporated by reference in its entirety for all purposes.

### BACKGROUND

The present disclosure relates generally to compressors, and more particularly, to screw compressors, which may be employed in HVAC&R (heating, ventilating, air conditioning, and refrigeration) systems, fuel gas boosting systems, gas compression systems, heat pump systems, and boil off gas compression systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Screw compressor rotors typically have helically extending lobes (or flutes) and grooves (or flanks) disposed on an outer surface of the rotor to form threads on the circumference of the rotor. During operation, the threads of adjacent rotors mesh with one another, with the lobes on one rotor meshing with corresponding grooves on the other rotor to form a series of gaps between the adjacent rotors. The gaps form a cyclical compression chamber that communicates with a suction port (e.g., a compressor inlet) at one end of the housing and continuously reduces in volume as the rotors turn to compress a gas (e.g., a refrigerant) and direct the gas toward a discharge port (e.g., a compressor outlet) at the opposite end of the housing. Accordingly, a pressure differential is generated between the suction port and the discharge port of the housing, which may impose an axial force on the rotors.

In most screw compressors, the male rotor drives (e.g., rotates) the female rotor. The female rotor may resist rotation due to the pressure differential between the suction port and discharge port, and thus, imposes an additional axial force on the male rotor of the compressor. The axial force applied to the male rotor, the female rotor, bearings, and/or other components of the compressor may generate frictional forces and bearing loads, which can significantly decrease an operational life of the compressor.

In some cases, a thrust bearing is used to mitigate the axial force imparted on certain compressor components. However, the operational life of the thrust bearing is reduced when the thrust bearing is placed under excessively high or excessively low axial loads. Existing screw compressors use a balance piston to generate a counter-force to adjust the axial force imparted on the thrust bearing. In some cases, a magnitude of the axial force generated by the compressor rotors may fluctuate based on operational conditions of the compressor. Unfortunately, adjusting the magnitude of the counter-force applied by the balance piston during operation of the compressor is complex, which may cause premature wear on the thrust bearing, the compressor rotors, and/or other compressor components.

### SUMMARY

The present disclosure relates to a bearing load control system that includes a force application device configured to apply a force to a bearing of a compressor and a sensor configured to provide feedback indicative of an operating parameter of the compressor. The bearing load control system also includes a controller that is communicatively coupled to the sensor and configured to determine an indication of a thrust force applied to the bearing based on the feedback indicative of the operating parameter. The controller is also configured to adjust the force application device to control the force applied to the bearing based at least in part on a control algorithm and the indication of the thrust force.

The present disclosure also relates to a bearing load control system for a compressor that includes a force application device disposed within a housing of the compressor, where the force application device is configured to apply a force to a shaft of the compressor. The bearing load control system includes a sensor configured to provide feedback indicative of an operational parameter of the compressor and a controller that is communicatively coupled to the sensor. The controller is configured to determine an indication of a thrust force applied to a bearing that is rotatably coupled the shaft based on feedback from the sensor. The controller is also configured to control the force applied by the force application device based at least in part on a control algorithm, such that a resultant force applied to the bearing is within a threshold range of a target bearing load.

The present disclosure also relates to a method of operating a bearing load control system of a compressor. The method includes acquiring feedback indicative of an operational parameter of the compressor using a sensor, monitoring a thrust force applied to a bearing of the compressor based on the feedback from the sensor, and actuating a force application device to apply a force to the bearing based on the thrust force.

### BRIEF DESCRIPTION OF THE DRAWINGS

Various aspects of this disclosure may be better understood upon reading the following detailed description and upon reference to the drawings in which:

FIG. 1 is a vertical cross-sectional view of an embodiment of a compressor, illustrating a bearing load control system and a slide valve in a loaded position, in accordance with an aspect of the present disclosure;

FIG. 2 is a vertical cross-sectional view of an embodiment of the compressor of FIG. 1, illustrating the slide valve in an unloaded position, in accordance with an aspect of the present disclosure;

FIG. 3 is a horizontal cross-sectional view of an embodiment of the compressor of FIG. 1, in accordance with an aspect of the present disclosure;

FIG. 4 is a flow chart of an embodiment of a method for operating the bearing load control system of FIGS. 1-3, in accordance with an aspect of the present disclosure; and

FIG. 5 is a flow chart of an embodiment of a method for operating the bearing load control system of FIG. 3 using a position probe, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

A vapor compression system may include a screw compressor that is configured to circulate or transfer a gas or a refrigerant through piping of the vapor compression system. The screw compressor may draw a vapor flow (e.g., a flow of refrigerant) through a compressor inlet and discharge the vapor flow through a compressor outlet. The screw compressor may include one or more cylindrical rotors that are formed integrally with respective shafts disposed inside a hollow rotor housing. The rotors of the compressor typically have helically extending lobes and grooves disposed on an outer surface of the rotors, which form threads along the circumference of the rotors. Gaps between the lobes and the grooves of the rotors form a cyclical compression chamber that extends along a length of the rotor housing. The cyclical compression chamber is in fluid communication with a suction port (e.g., an axial port near the compressor inlet) at one end of the rotor housing and a discharge port (e.g., an axial port near the compressor outlet) at an opposite end of the rotor housing. The gaps between the lobes and grooves may continuously decrease in volume from the suction port toward discharge port, such that low pressure vapor entering the compressor inlet is compressed and discharged as high pressure vapor through the compressor outlet.

A substantial pressure differential may be generated between the compressor inlet and the compressor outlet, which may impose a first axial force on the rotors of the screw compressor (e.g., a resultant force applied to the rotors in a first direction from the discharge port toward the suction port). In some cases, helically extending lobes of a first rotor (e.g., a male rotor) may engage with helically extending grooves of a second rotor (e.g., a female rotor), such that the first rotor may drive (e.g., rotate) the second rotor. The second rotor may resist rotation due to the pressure differential between the compressor outlet and the compressor inlet. As such, the helically extending grooves of the second rotor may impose a second axial force (e.g., a resultant force) on the first rotor, which may act along the same direction as the first axial force (e.g., from the discharge port toward the suction port).

As discussed in greater detail herein, a magnitude of the first axial force, the second axial force, or both, may vary when a capacity (e.g., a discharge flow rate, a discharge pressure) of the compressor is adjusted and/or when a volume ratio (e.g., a compression ratio) of the compressor is adjusted. For example, the compressor may include a moveable slide valve that is configured to adjust an amount of vapor that discharges from the compression chamber through a bypass passage of the compressor, prior to being directed through the compressor outlet. In this manner, the slide valve may adjust a flow rate of vapor (e.g., the high pressure vapor) that is exhausted through the compressor outlet during operation of the compressor. That is, the slide valve may adjust a capacity of the compressor. Additionally, in some embodiments, the compressor may include a movable slide stop that is configured to adjust the volume ratio of the compressor. Particularly, the slide stop may be configured to increase or decrease a distance along which vapor is forced through the cyclical compression chamber (e.g., a thread pressure of the compressor). As such, it should be understood that adjustments to the position of the slide valve and/or the position of the slide stop may significantly vary a magnitude of axial forces (e.g., the first axial force and/or the second axial force) that may be applied to the rotor(s) during operation of the compressor.

In many cases, a bearing, such as a thrust bearing, may be radially coupled to a shaft of the first rotor and used to substantially block axial movement (e.g., axial vibrations) of the first rotor due to the first axial force and/or the second axial force (e.g., due to a summation of individual axial force vectors acting on the first rotor). An operational life of the thrust bearing may be increased when an axial load imposed on the thrust bearing is substantially similar (e.g., substantially equal) to a predetermined thrust load of the thrust bearing. In some cases, the axial force imparted onto the thrust bearing during operation of the compressor may substantially deviate from the predetermined thrust load of the thrust bearing, thus causing the thrust bearing to incur wear and reducing the operational life of the thrust bearing. Accordingly, a balance piston may be used to apply a counter-force to the first rotor that is opposite in direction to the first axial force and/or the second axial force. However, typical balance piston control systems are unable to effectively adjust a magnitude of the counter-force applied by the balance piston as a magnitude of the first and/or the second axial force changes. The thrust bearing may thus experience axial loads which deviate from the predetermined thrust load during transient operational conditions of the compressor, which may reduce the operational life of the thrust bearing.

Embodiments of the present disclosure are directed to a bearing load control system that may be used to regulate a counter-force applied to the first rotor by a force application device, such as a balance piston, in response to deviations of the first and/or second axial forces. As such, the bearing load control system enables a magnitude of the axial force experienced by the thrust bearing to be maintained at a value that is substantially equal to, or within a threshold range of, the predetermined thrust load of the thrust bearing.

The bearing load control system may include a controller that is configured to control a valve (e.g., a stepless pressure control valve) that adjusts a pressure of fluid supplied to the balance piston. The pressure of fluid may adjust a magnitude of the counter-force applied to the thrust bearing by the balance piston. The controller may monitor operational parameters of the compressor and use an algorithm (e.g., an optimization algorithm) to adjust the balance piston pressure in response to changes in the monitored operational parameters of the compressor. The algorithm may thus enable the controller to adjust the counter-force applied by the balance piston, such that the axial force experienced by the thrust bearing is within a threshold range of the predetermined thrust load over various operational conditions of the compressor.

In some embodiments, the controller may be communicatively coupled to a position probe, which may measure a position of the first rotor and/or a position of the second rotor within the rotor housing. The position of the rotors may correlate to a magnitude of the first and/or second axial forces (e.g., resultant forces) imposed on the rotor and, thus, a magnitude of a total axial force imposed on the thrust bearing. The controller may adjust the counter-force applied by the balance piston based on the measured position(s) of the rotors(s). For example, the controller may adjust a pressure of fluid supplied to the balance piston when the position or the rotor(s) deviates from a target position by a threshold value. Accordingly, the bearing load control system may be used to maintain an axial load applied to the thrust bearing at the predetermined thrust load during operation of the compressor. It should be noted that throughout the following disclosure, the term “measure” may refer to any acquisition of feedback relating to an operating parameter of the compressor through observation of direct or indirect indicators of the operating parameter. Moreover, the term “sensor” may include any suitable instrument capable of acquiring the feedback through direct or indirect observation indicators.

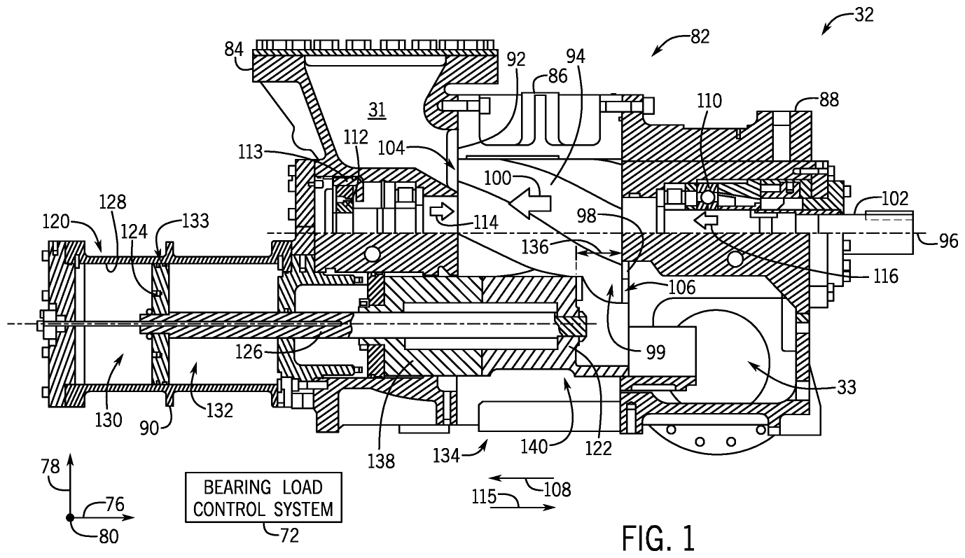

Turning now to the drawings, FIG. 1 illustrates a cross-sectional view of an embodiment of a compressor 32 and a bearing load control system 72 that may be used in a vapor compression system. To facilitate discussion, the compressor 32 and its components may be described with reference to a longitudinal axis or direction 76, a vertical axis or direction 78, and a lateral axis or direction 80. The compressor 32 may include a compressor housing 82 that includes working components (e.g., bearings, rotors) of the compressor 32. As described in greater detail herein, the compressor housing 82 may include an intake portion 84, a rotor portion 86, a discharge portion 88, and a slide valve portion 90.

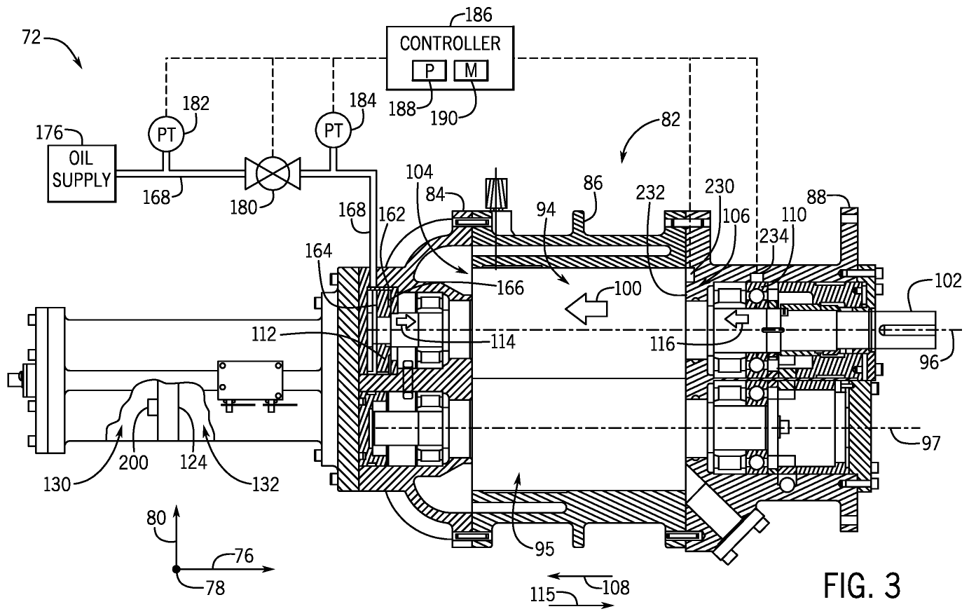

In some embodiments, the intake portion 84 may form a passage that defines the compressor inlet 31. Vapor (e.g., a gaseous refrigerant) from the vapor compression system may flow through the compressor inlet 31 and enter the rotor portion 86 at a suction port 92. The compressor 32 may include a male rotor 94 and a female rotor 95 (as shown in FIG. 3) that are disposed within the rotor portion 86. The male rotor 94 and the female rotor 95 may rotate about a first axis 96 and a second axis 97 (as shown in FIG. 3) of the rotor portion 86, respectively, which extend parallel to a central axis of the compressor 32 from the intake portion 84 to the discharge portion 88. The male rotor 94 may include one or more protruding lobes disposed axially along a length of the male rotor 94 and the female rotor 95 may include one or more corresponding grooves configured to receive the lobes of the male rotor 94 along a length of the female rotor 95.

As discussed above, the lobes on the male rotor 94 may mesh with the corresponding grooves on the female rotor 95 to form a series of gaps between the rotors. The gaps may form a cyclical compression chamber that is in fluid communication with the suction port 92 and an axial discharge port 98 disposed within the discharge portion 88. During operation of the compressor 32, the gaps may continuously reduce in volume when the rotors rotate and thus compress the vapor along the length of the rotors from the suction port 92 toward the axial discharge port 98. The compressed vapor may exit the compression chamber through the axial discharge port 98 and, as discussed in detail below, through a radial discharge passage 99, such that the compressed vapor may flow out of the compressor 32 though the compressor outlet 33.

As discussed above, an axial force 100 may be imposed on a shaft 102 of the male rotor 94 and/or a shaft of the female rotor 95 during operation of the compressor 32. The axial force 100 may be generated due to a pressure differential between a first end portion 104 of the rotors (e.g., near the compressor inlet 31) and a second end portion 106 of the rotors (e.g., near the compressor outlet 33). For example, a first pressure of the vapor within the compressor inlet 31 may be substantially less (e.g., 2 times less, 20 times less, or more) than a second pressure of the vapor within the compressor outlet 33. Accordingly, a difference between the second pressure and the first pressure may generate the axial force 100, which may push the rotors in direction 108. In some embodiments, the male rotor 94 may be configured to drive (e.g., rotate) the female rotor 95 (e.g., rotation of the shaft of the female rotor 95 is not driven by a motor or external drive). For example, the helical lobes of the male rotor 94 may engage with the helical grooves of the female rotor 95, such that rotation of the male rotor 94 may induce rotation of the female rotor 95. The female rotor 95 may resist rotation (e.g., due to the pressure differential between the end portions 104, 106 of the rotors) and thus impose an axial thrust on the male rotor 94. The axial thrust may act in direction 108, and thus increase a magnitude of the axial force 100 imposed on the male rotor 94.

In some embodiments, the axial force 100 may be transmitted to a bearing, such as a thrust bearing 110, which is radially coupled to the shaft 102 of the male rotor 94. While the illustrated embodiment of FIG. 1 shows the compressor 32 having a single thrust bearing 110, it should be noted that the compressor 32 may include two, three, or more than three thrust bearings disposed adjacent to one another. As described in greater detail herein, the thrust bearing 110 may counter-act a substantial portion of the axial force 100, such that the axial force 100 does not induce damage to certain compressor components. In some embodiments, when the axial force 100 deviates from a predetermined thrust load (e.g., a predetermined bearing load) of the thrust bearing 110, the axial force 100 may reduce an operational life (e.g., revolutions before failure) of the thrust bearing 110, due to excess forces imposed on the thrust bearing 110. In some embodiments, the thrust bearing 110 includes an axial contact ball bearing, a four-point ball bearing, or another suitable bearing configured to at least partially counter-act the axial force 100.

Accordingly, a force application device, such as a balance piston 112, may be disposed within a portion of the compressor housing 82 (e.g., the intake portion 84) and configured to impose a regulating force 114 (e.g., a counter-force) on the shaft 102. In some embodiments, the balance piston 112 may be positioned within a sleeve 113 that enables the balance piston 112 to rotate relative to the compressor housing 82. For example, in some embodiments, the balance piston 112 may rotate about the first axis 96 with the male rotor 94 at a rotational speed that may be substantially equal to or less than a rotational speed of the male rotor 94. In any case, the regulating force 114 may be opposite in direction (e.g., in direction 115 along the axis 76) to the axial force 100. A sum of a magnitude of the axial force 100 and a magnitude of the regulating force 114 may thus generate a resultant force 116, which ultimately acts on the shaft 102, and thus the thrust bearing 110. A magnitude of the resultant force 116 may act along the direction 108, or along the direction 115. An operational life of the thrust bearing 110 may be increased when a magnitude of the resultant force 116 is substantially equal to, or within a threshold range of, the predetermined thrust load of the thrust bearing 110. As discussed in greater detail herein, the regulating force 114 generated by the balance piston 112 may be adjusted by the bearing load control system 72 as the axial force 100 varies, thereby enabling the magnitude of the resultant force 116 to be maintained at a value that is substantially equal to (e.g., within 10% of, within 5% of, within 1% of) a magnitude of the predetermined thrust load of the thrust bearing 110 during operation of the compressor 32. Indeed, as discussed below, a magnitude of the axial force 100 may fluctuate based on, for example, a position of a slide valve, a position of a slide stop of the compressor 32, a suction pressure of the compressor 32, a discharge pressure of the compressor 32, a capacity of the compressor 32, a temperature and/or pressure of refrigerant in an economizer, or any combination thereof. As such, adjusting a magnitude of the regulating force 114 in response to deviations in the magnitude of the axial force 100 may enable the bearing load control system 72 to increase an operational life of the thrust bearing 110. In particular, the bearing load control system 72 may enable the thrust bearing 110 to operate effectively for a target operational life.

In certain embodiments, the force application device may include a magnetic bearing and/or another suitable electronically actuated force application device that is used in addition to, or in lieu of, the balance piston 112. In some embodiments, the magnetic bearing may be indicated by reference numeral 112. The magnetic bearing may be used to levitate the shaft 102 of the male rotor 94 during operation of the compressor 32, while also generating the regulating force 114 on the shaft 102. As described in greater detail herein, the magnetic bearing may be controlled to adjust the regulating force 114, such that the resultant force 116 is substantially similar to the predetermined thrust load. In still further embodiments, the force application device may include any other suitable device that may be used to generate and adjust the regulating force 114.

As noted above, in some embodiments, the compressor 32 may include a slide valve assembly 120, which may be actuatable to adjust a capacity (e.g., a suction volume, a discharge flow rate) of the compressor 32. For example, the slide valve assembly 120 may include a valve body 122 (e.g., a slide valve) and a piston 124 that are coupled to one another via a shaft 126. The piston 124 may be disposed within a cylinder 128 of the slide valve portion 90, and thus divide the slide valve portion 90 into a front chamber 130 and a rear chamber 132 on either side of the piston 124. Seals 133 disposed between the piston 124 and the cylinder 128 may block fluid from flowing around the piston 124 from the front chamber 130 to the rear chamber 132, or vice versa.

The piston 124 may be configured to move axially (e.g., along the longitudinal direction 76) within the cylinder 128 when a pressure differential is generated between the front chamber 130 and the rear chamber 132. For example, increasing a pressure within the front chamber 130 relative to a pressure within the rear chamber 132 may enable the piston 124 to slide axially in the direction 115 (e.g., toward the compressor outlet 33). Axial motion of the piston 124 may be transferred to the valve body 122 via the shaft 126, and thus induce axial motion (e.g., in the direction 115) of the valve body 122.

The valve body 122 may form a lower end portion 134 of the rotor portion 86, such that movement of the valve body 122 may adjust a width 136, and therefore a cross-sectional area, of the radial discharge passage 99. The radial discharge passage 99 may direct the vapor from the compression chamber toward the compressor outlet 33 of the discharge portion 88. As discussed below, adjusting a position (e.g., an axial position) of the valve body 122 relative to a slide stop 138 of the compressor 32 may enable the valve body 122 to increase or decrease a volumetric flow rate of vapor that may be discharged from the compressor 32 via the compressor outlet 33. In the illustrated embodiment, the valve body 122 is in a loaded position 140, such that a volumetric flow rate of vapor discharging from the compressor 32 is relatively large. Indeed, in the loaded position 140 of the valve body 122, the compressor 32 may direct substantially all refrigerant that is drawn into the compressor housing 83 (e.g., via the compressor inlet 31) to the compressor outlet 33. That is, the compressor 32 may direct a relatively high volumetric flow rate of vapor through the vapor compression system when the valve body 122 is in the loaded position 140. Accordingly, a pressure differential across the rotor portion 86 and, thus, a magnitude of the axial force 100, may be relatively large. As used herein, the “loaded position” of the valve body 122 may corresponding to a position of the valve body 122 in which the valve body 122 physically contacts (e.g., abuts) the slide stop 138.

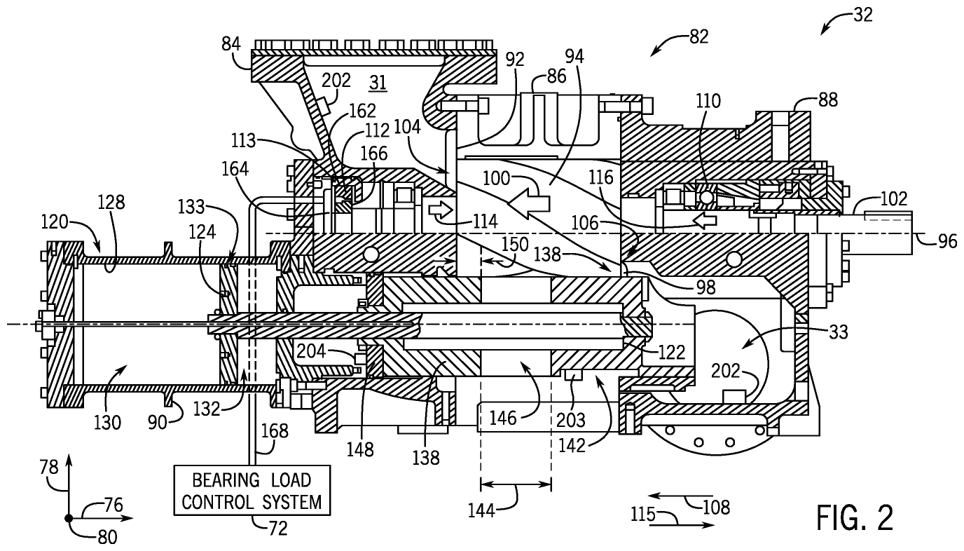

FIG. 2 illustrates a cross-sectional view of the compressor 32 in which the valve body 122 is in an unloaded position 142, such that the compressor 32 is configured to direct a relatively small volumetric flow rate of vapor through the vapor compression system. For example, in the illustrated embodiment, the radial discharge passage 99 is fully closed (e.g., the cross-sectional area of the radial discharge passage 99 is substantially zero). Indeed, movement of the valve body 122 in the direction 115 (e.g., toward the unloaded position 142) may increase a width 144 (e.g., a distance between the slide stop 138 and the valve body 122), and therefore a cross-sectional area, of a bypass passage 146. In some embodiments, the vapor directed through the bypass passage 146 may be recirculated to the compressor inlet 31 instead of discharging through the compressor outlet 33. As such, translational movement of the valve body 122 between the loaded position 140 and the unloaded position 142 may increase or decrease the cross-sectional area of the bypass passage 146, and thus, may decrease or increase, respectively, a volumetric flow rate of vapor that the compressor 32 may discharge through the compressor outlet 33.

As discussed previously, adjusting a pressure differential between the front chamber 130 and the rear chamber 132 may enable the piston 124, and thus the valve body 122, to slide axially along the longitudinal axis 76 and move between the loaded position 140 and the unloaded position 142. Additionally or alternatively, the valve body 122 may be disposed in any position between the loaded position 140 and the unloaded position 142. The position of the valve body 122 may be maintained by balancing the pressure differential between the front and rear chambers 130, 132.

In some embodiments, the slide stop 138 may be coupled to a suitable actuator of the compressor 32, such as a piston 148, which is configured to translate the slide stop 138 relative to the compressor housing 82 in the direction 108 and the direction 115. Such translational movement of the slide stop 138 may enable the slide stop 38 to adjust a volume ratio (e.g., a compression ratio) of the compressor 32. For example, in certain embodiments, the piston 148 may be actuated to translate the slide stop 138 in the direction 108 to decrease an overlap distance 150 between the slide stop 138 and the male and female rotors 94, 95. Accordingly, the slide stop 138 may decrease a distance along which refrigerant is forced through the cyclical compression chamber (e.g., the cyclical compression chamber formed between the male and female rotors 94, 95) during operation of the compressor 32, and thus, reduce a volume ratio of the compressor 32. Conversely, the piston 148 may be actuated to translate the slide stop 138 in the direction 115 to increase the overlap distance 150 between the slide stop 138 and the male and female rotors 94, 95. Therefore, the slide stop 138 may increase a distance along which refrigerant is forced through the cyclical compression chamber and, as a result, increase a volume ratio of the compressor 32.

In some embodiments, the magnitude of the axial force 100 may vary as the capacity of the compressor 32 is adjusted (e.g., when the valve body 122 is moved) and/or as the volume ratio of the compressor 32 is adjusted (e.g., when the slide stop 138 is moved). For example, the axial force 100 may increase when the valve body 122 is directed toward the loaded position 140, in which substantially all refrigerant entering the compressor 32 discharges through the compressor outlet 33. Additionally or alternatively, the axial force 100 may increase as the slide stop 138 translates in the direction 115 to increase a compression ratio of the compressor 32 (e.g., by increasing the overlap distance 150). Conversely, the axial force 100 may decrease when the valve body 122 translates toward the unloaded position 142, in which a portion the vapor entering the compressor 32 (e.g., via the compressor inlet 31) may prematurely discharge from the cyclical compressor chamber through the bypass passage 146. Further still, the axial force may decrease as the slide stop 138 translates in the direction 108 to decrease the compression ratio of the compressor 32 (e.g., by decreasing the overlap distance 150). Accordingly, it should be appreciated that selectively adjusting the regulating force 114 applied to the thrust bearing 110 by the balance piston 112 in response to variations in the axial force 100 caused by adjustments of the valve body 122, the slide stop 138, and/or another compressor component, may maintain the resultant force 116 at a value that is within a threshold range of the predetermined thrust load of the thrust bearing 110.

The bearing load control system 72 may be used to adjust the regulating force 114 applied to the thrust bearing 110 by the force application device such as, for example, the balance piston 112. For example, the balance piston 112 may be disposed within a cylinder 162, such that the cylinder 162 is divided into a first chamber 164 and a second chamber 166. The first chamber 164 may be in fluid communication with the bearing load control system 72 and the second chamber 166 may be in fluid communication with the compression chamber of the compressor 32. In some embodiments, a sealing component of the balance piston 112 may form a fluidic seal between the first chamber 164 and the second chamber 166, such that fluid (e.g., oil) is substantially blocked from flowing between the first and second chambers 164, 166. In other embodiments, a small quantity of oil may be configured to flow past the balance piston 112, such that the oil may lubricate internal components of the compressor 32 (e.g., bearings, the shaft 102, the rotors 94, 95). In still further embodiments, a fluid (e.g., the oil) may be directed into the compressor as lubrication via a separate port or inlet. In any case, the bearing load control system 72 may be used to supply a fluid (e.g., the oil) to the first chamber 164 via a supply line 168 (e.g., piping). As described in greater detail herein, the bearing load control system 72 may be configured to adjust a pressure of the fluid, and thus adjust a magnitude of the regulating force 114 applied to the thrust bearing 110 by the balance piston 112, during various operational conditions of the compressor 32 (e.g., various positions of the valve body 122 and/or the slide stop 138).

With the foregoing in mind, FIG. 3 illustrates a cross-sectional plan view of the compressor 32. As discussed above, the female rotor 95 may be disposed adjacent to the male rotor 94 and may rotate about the second axis 97 of the rotor portion 86. The female rotor 95 may be driven by the male rotor 94, and thus contribute to the axial force 100 imposed on the male rotor 94. The regulating force 114 generated by the balance piston 112 may be maintained or controlled by adjusting the pressure of fluid (e.g., oil) delivered from an oil supply 176. In some embodiments, the oil supply 176 may include a lubrication circuit for the compressor that has an oil pump configured to supply oil to the compressor 32 for lubrication of certain compressor components, such as the male and female rotors 94, 95 and/or bearings. The oil supply 176 may direct a portion of lubricant from the lubrication circuit toward the balance piston 112 via the supply line 168. In other embodiments, the oil supply 176 may include a lubrication system of the compressor 32 that does not include a pump, but otherwise directs lubricant from the lubrication system toward the balance piston 112 via the supply line 168.

In any case, the pressure of the fluid delivered to the first chamber 164 by the oil supply 176 may be controlled by a valve 180 (e.g., a single step-less control valve, a motorized valve, or a ball valve). For example, the valve 180 may enable a flow rate of fluid flowing toward the first chamber 164 to be adjusted, thus controlling a pressure drop across the valve 180. A first pressure sensor 182 (e.g., a first piston fluid sensor) upstream of the valve 180 and a second pressure sensor 184 (e.g., a second piston fluid sensor) downstream of the valve 180 may monitor the pressure drop across the valve 180. It should be noted that the first pressure sensor 182 and the second pressure sensor 184 may be different types of devices and may provide direct or indirect indications of pressure. For example, the first pressure sensor 182 and the second pressure sensor 184 may include any suitable pressure measuring instrument, such as a pressure transducer, a pressure transmitter, a manometer, or the like. In some embodiments, a controller 186 of the bearing load control system 72 may be used to control the valve 180, and thus adjust the magnitude of the regulating force 114 generated by the balance piston 112. As described in greater detail herein, in some embodiments, the controller 186 may control the valve 180 based on feedback acquired from the first pressure sensor 182 and/or the second pressure sensor 184. Additionally or alternatively, the controller 186 may control the valve 180 based on various sensors that may provide feedback indicative of a position of the valve body 122, a position of the slide stop 138, a suction pressure within the compressor inlet 31, a discharge pressure within the compressor outlet 33, a temperature and/or pressure of refrigerant in an economizer, or any combination thereof.

In some embodiments, one or more control transfer devices, such as wires, cables, wireless communication devices, and the like, may communicatively couple the controller 186, the valve 180, the first pressure sensor 182, the second pressure sensor 184, and/or a plurality of additional sensors of the compressor 32 to one another. The controller 186 includes a processor 188 (e.g., a microprocessor) that may execute software, such as software for controlling the valve 180. Moreover, the processor 188 may include multiple microprocessors, one or more “general-purpose” microprocessors, one or more special-purpose microprocessors, and/or one or more application specific integrated circuits (ASICS), or some combination thereof. For example, the processor 188 may include one or more reduced instruction set (RISC) processors.

The controller 186 also includes a memory device 190 that may store information such as control software, look up tables, configuration data, etc. The memory device 190 may include a volatile memory, such as random access memory (RAM), and/or a nonvolatile memory, such as read-only memory (ROM). The memory device 190 may store a variety of information and may be used for various purposes. For example, the memory device 190 may store processor-executable instructions (e.g., firmware or software) for the processor 188 to execute, such as instructions for controlling the valve 180. In some embodiments, the memory device 190 is a tangible, non-transitory, machine-readable-medium that may store machine-readable instructions for the processor 188 to execute. The memory device 190 may include ROM, flash memory, a hard drive, or any other suitable optical, magnetic, or solid-state storage medium, or a combination thereof. The memory device 190 may store data, instructions, and any other suitable data. As discussed in greater detail herein, the memory device 190 may store data that is indicative of the predetermined thrust load of the thrust bearing 110 during various operational conditions (e.g., adjustments in capacity) of the compressor 32. The controller 186 may be configured to instruct the valve 180 to adjust the regulating force 114 applied to the thrust bearing by the balance piston 112, such that the resultant force 116 is substantially close to the predetermined thrust load during operation of the compressor 32.

As discussed above, the operational life of the thrust bearing 110 may be increased when the thrust bearing 110 operates within a threshold range of the predetermined thrust load. For example, forces (e.g., frictional forces) may cause premature wear on the thrust bearing 110 when a thrust load (e.g., a bearing load) on the thrust bearing 110 is above the predetermined thrust load. Similarly, when a thrust load on the thrust bearing 110 is below the predetermined thrust load, the thrust bearing 110 may wear prematurely due to unwanted slip between certain bearing components (e.g., between ball bearings and races). Laboratory trials may be used to empirically determine a magnitude of the resultant force 116 that corresponds to a target operational life (e.g., an increased operational life) of the thrust bearing 110 while the compressor 32 operates under specific operating conditions. This magnitude of the resultant force 116 may be indicative of the predetermined thrust load corresponding to these operating conditions of the compressor 32. For clarity, the target operational life of the thrust bearing 110 may correspond to an operational period of the thrust bearing 110 during which the thrust bearing 110 operates effectively (e.g., operates within a set of threshold parameters).

For example, in order to determine the predetermined thrust load of the thrust bearing 110 for specific operating parameters of the compressor 32, a plurality of sensors may be disposed on or within the compressor 32 and used to measure certain operational parameters of the compressor 32. For example, in some embodiments, a position sensor 200 (e.g., a linear transducer, a linear transmitter, or any other suitable position measuring instrument) may be disposed on the piston 124 of the slide valve assembly 120 and used to measure an axial position of the piston 124 relative to the compressor housing 82. In certain embodiments, the axial position of the piston 124 may correspond to an axial position of the valve body 122. Additionally or alternatively, the bearing load control system 72 may include a position sensor 203 (e.g., as shown in FIG. 2) that may be coupled to the valve body 122, or any other suitable component of the slide valve assembly 120, and used to measure the axial position of the valve body 122.

In some embodiments, the compressor 32 may include one or more pressure sensors that are positioned within the front chamber 130, the rear chamber 132, or both, and configured to provide the controller 186 with feedback indicative of a pressure within the front chamber 130 and/or the rear chamber 132. The pressure within the front chamber 130 and/or the rear chamber 132 may be indicative of a position of the valve body 122. Accordingly, the controller 186 may determine a position of the valve body 122 based on feedback indicative of the pressure or pressures acquired by the one or more pressure sensors within the front and/or rear chambers 130, 132. In some embodiments, an additional position sensor 204 (as shown in FIG. 2) may be coupled to the slide stop 138 and/or, for example, the piston 148, and used to measure an axial position of the slide stop 138 relative to the compressor housing 82. For example, in some embodiments, an axial position of the piston 148 (e.g., relative to the compressor housing 82) may correspond to an axial position of the slide stop 138. Additionally or alternatively, suitable pressure sensors disposed on either side of the piston 148 may enable the controller 186 to determine a position of the slide stop 138 in accordance with the techniques discussed above. That is, the position of the slide stop 138 may be indicative of a pressure differential between opposing sides of the piston 148. It should be appreciated that any of the sensors (e.g., the sensors 200, 203, 204) discussed herein may be communicatively coupled to the bearing load system 72 (e.g., to the controller 186 of the bearing load system 72) using suitable wired connections and/or wireless connections that enable the sensors to provide feedback to the controller 186.

In certain embodiments, one or more pressure sensors 202 (as shown in FIG. 2) may be disposed within the compressor inlet 31 and/or the compressor outlet 33 and configured to measure a suction pressure and/or a discharge pressure of the compressor 32, respectively. As described in greater detail herein, the axial force 100 imparted on the thrust bearing 110 (e.g., due to the pressure differential between the compressor inlet 31 and the compressor outlet 33), an operational life of the thrust bearing 110, and the operational parameters (e.g., slide valve position, the slide stop position, the suction pressure, the discharge pressure, the temperature and/or pressure of refrigerant in an economizer) of the compressor 32 may be measured and/or recorded (e.g., via data logging software, or an operator evaluating manual indicators) during the experimental trials. Multiple experimental trials may be conducted in which the operational parameters of the compressor 32 are systematically varied, such that an operational life of the thrust bearing 110 may be determined or estimated (e.g., via interpolation or another suitable technique) for each set of operational parameters. As discussed above, the predetermined thrust load may be indicative of the resultant force 116 imparted on the thrust bearing 110 that enables the thrust bearing 110 to reach the target operational life for each set of operating parameters of the compressor 32. Accordingly, the predetermined thrust load of the thrust bearing 110 may be determined for each set of operational parameters. The results of the experimental trials may be used to generate an algorithm (e.g., a control algorithm), which may be stored (e.g., in the memory device 190) and implemented by the controller 186. In some embodiments, the algorithm may include an optimization algorithm that is used to enhance an operational life of the thrust bearing 110. For example, as described in greater detail herein, the algorithm may enable the controller 186 to control the fluid pressure directed to the first chamber 164 of the balance piston 112 (e.g., via the valve 180), such that the balance piston 112 may adjust the regulating force 114 and enable the resultant force 116 to be within a threshold range of the predetermined thrust load. In some embodiments, the predetermined thrust load of the thrust bearing 110 is determined by iteratively reducing an oil pressure of the balance piston 112 until a vibration threshold of the thrust bearing 110 is reached. From that oil pressure, the predetermined thrust load of the thrust bearing may be determined.

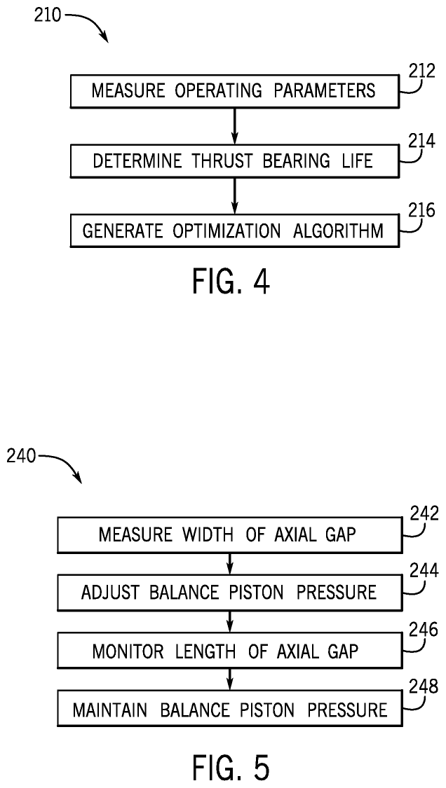

With the foregoing in mind, FIG. 4 is a block diagram of an embodiment of a method 210 that may be used to generate the algorithm. It should be understood that the below discussion focuses on one embodiment of the algorithm, and that the algorithm may be generated through additional and/or different steps than those discussed below. At block 212, the compressor 32 may be operated in an experimental setting, such that a first set of operational parameters of the compressor 32 are measured and/or recorded. As discussed above, the operational parameters may include a position of the piston 124, a position of the valve body 122, a position of the slide stop 138, a suction pressure within the compressor inlet 31, a discharge pressure within the compressor outlet 33, a temperature and/or pressure of refrigerant in an economizer, and/or any other suitable operating parameters of the compressor 32. In addition, a magnitude of the regulating force 114 generated by the balance piston 112 may be measured and recorded. For example, the pressure of fluid supplied to the first chamber 164 of the balance piston 112 may be measured by measuring the pressure differential across the first and second pressure sensors 182, 184. Accordingly, a magnitude of the regulating force 114 applied by the balance piston 112 may be calculated using at least the pressure differential and the cross-sectional area of the balance piston 112. As such, the axial force 100 imposed on the male rotor 94 and the resultant force 116 imposed on the thrust bearing 110 corresponding to the first set of operational parameters may also be measured and recorded. The compressor 32 may be operated under the first set of operational parameters for a predetermined amount of time. At block 214, a thrust bearing life indicative of the first set of operating parameters may be determined after the predetermined amount of time has elapsed. For example, the operation life of the thrust bearing 110 may be estimated by evaluating wear (e.g., pitting, material fatigue) incurred by the thrust bearing 110. In some embodiments, the operational life of the thrust bearing may be estimated through online monitoring (e.g., real-time monitoring) techniques, which monitor vibrations of the thrust bearing 110 during operation of the compressor 32. In other embodiments, the compressor 32 may be operated under the first set of operating parameters until the thrust bearing 110 no longer operates efficiently and/or effectively.

In some embodiments, iterative tests may be run in which a single parameter of the set of operating parameters is adjusted during a respective test. For example, the pressure of the fluid within the first chamber 164 of the balance piston 112 may be adjusted while all other operation parameters of the compressor 32 are kept substantially constant. The compressor 32 may be operated under the adjusted set of operating parameters (e.g., a second set of operating parameters) for the predetermined amount of time, such that the operational life of the thrust bearing 110 indicative of the second set of operating parameters may be determined. Multiple iterative tests may be run to determine the operational life of the thrust bearing 110 for each set of operational parameters of the compressor 32. In some embodiments, the compressor 32 can be run through 1, 2, 3, 4, 5, 10, 50 or more iterative tests to collect data indicative of the operational life of the thrust bearing 110 corresponding to each set of operational parameters. At block 216, the results of the iterative tests may be used to generate an algorithm that may be used to enhance the operational life of the thrust bearing 110 by adjusting the regulating force 114 using the bearing load control system 72.

For example, data collected during the iterative tests may be used to determine which resultant force 116 imposed on the thrust bearing 110 results in the thrust bearing 110 achieving the target operational life, while the compressor 32 operates under a certain set of operational parameters. This resultant force 116 may be recorded and stored (e.g., in the memory device 190), and is indicative of the predetermined thrust load of the thrust bearing 110 for the given set of operational parameters. The algorithm may correlate (e.g., via look-up tables, mathematical functions) certain operational parameters of the compressor 32 with the predetermined thrust load on the thrust bearing 110 corresponding to the given set of operational parameters. As such, the controller 186 may use the algorithm during operation of the compressor 32 to adjust the regulating force 114 applied to the balance piston 112, which enables the thrust bearing 110 to operate under an axial load that is within a threshold range of the predetermined thrust load.

For example, the controller 186 may receive feedback from one or more sensors (e.g., the sensors 200, 202, 203, 204) indicative of various operational parameters of the compressor 32. The one or more sensors may include any measuring instruments that are suitable to directly or indirectly observe certain operational parameters of the compressor 32, such as pressure sensors (e.g., pressure transmitters, pressure transducers, etc.), position sensors (linear transmitters, optical sensors, etc.), thermal sensors (e.g., thermistors, thermocouples, etc.), or the like. The controller 186 may use these operational parameters as inputs to the algorithm. For example, as discussed above, the controller 186 may monitor the position of the piston 124, the position of the valve body 122, the position of the slide stop 138, the suction pressure in the compressor inlet 31, the discharge pressure in the compressor outlet 33, a temperature and/or pressure of refrigerant in an economizer, and/or any additional suitable parameter of the compressor 32. The controller 186 may use the measured operational parameters and the algorithm to determine a magnitude of the predetermined thrust load corresponding to the measured operational parameters. As such, the controller 186 may adjust a magnitude of the regulating force 114 when a difference between the resultant force 116 and the predetermined thrust load for a certain set of operational parameters exceeds a threshold value. Accordingly, the algorithm may maintain an axial load applied to the thrust bearing 110 at a value that is within a threshold range of the predetermined thrust load corresponding to the current operational parameters of the compressor 32.

As noted above, in some embodiments, the controller 186 may monitor a pressure differential across the valve 180 using the first and second pressure sensors 182, 184 disposed on the supply line 168. When the controller 186 determines that the magnitude of the resultant force 116 deviates from the predetermined thrust load by a threshold amount, the controller 186 may adjust the valve 180 to adjust the pressure within the first chamber 164, and thus adjust the magnitude of the regulating force 114. The regulating force 114 may counter-act at least a portion of the axial force 100, which adjusts the magnitude of the resultant force 116. Additionally or otherwise, the controller 186 may instruct any other suitable force application device that may be used in the bearing load control system 72, such as the magnetic bearing, to adjust the magnitude of regulating force 114. In any case, the controller 186 may continuously monitor the operational parameters of the compressor 32 and use the algorithm to maintain the resultant force 116 at a value that is within a threshold range of the predetermined thrust load of the thrust bearing 110, and thus increase the operational life of the thrust bearing 110. As noted above, it should be understood that the algorithm may include additional or fewer steps than those discussed herein.

Returning now to FIG. 3, in some embodiments, the bearing load control system 72 may include a position probe 230 that may measure a separation distance between the second end portion 106 of the male rotor 94 and/or the female rotor 95 and an inner surface 232 of the discharge portion 88. In other words, the position probe 230 may measure a position of the male rotor 94 and/or the female rotor 95 within the rotor portion 86 of the compressor 32. The position probe 230 may be disposed within a recess of the discharge portion 88, or in any other suitable location of the compressor 32. For example, in some embodiments, the position probe 230 may be disposed within the intake portion 84 and configured to measure a separation distance between an inner surface of the intake portion 84 and the first end portion 104 of the male rotor 94 and/or the female rotor 95. In some embodiments, a second position probe 234 may be used to measure an axial deflection, or displacement, of the thrust bearing 110 in addition to, or in lieu of, the position probe 230. The second position probe 234 may be coupled to the discharge portion 88 of the compressor housing 82 and disposed adjacent to the thrust bearing 110. As such, the second position probe 234 may measure axial movement of a first portion of the thrust bearing 110 (e.g., an inner ring) relative to a second portion of the thrust bearing 110 (e.g., an outer ring). In other embodiments, the second position probe 234 may be configured to provide feedback indicative of a contact angle of a ball of the thrust bearing 110. In still further embodiments, another suitable sensing device may be configured to monitor a parameter indicative of load applied to the thrust bearing 110, which may correspond to axial deflection of one or more portions of the thrust bearing 110. The measurements acquired by the position probe 230 and/or the second position probe 234 may be used in addition to, or in lieu of, the algorithm discussed above to facilitate enhancement of the operational life of the thrust bearing 110.

As discussed above, an increase in the capacity of the compressor 32 (e.g., when the valve body 122 moves toward the loaded position 140) and/or increasing the compression ratio of the compressor 32 (e.g., when the slide stop 138 moves in the direction 115) may result in an increase in the magnitude of the axial force 100. In some embodiments, the increased axial force 100 may move the shaft 102 of the male rotor 94 in the direction 108, which increases the separation distance measured by the position probe 230. Similarly, the axial force 100 may generate axial deflections within the thrust bearing 110, which may be measured by the second position probe 234. The position probe 230 and/or the second position probe 234 may thus be used to monitor deviations in the axial force 100 imparted on the male rotor 94, the female rotor 95, or both.

As discussed above, the predetermined thrust load of the thrust bearing 110 may be empirically determined through experimental tests. As such, the predetermined thrust load may also be associated with a target separation distance (e.g., a separation distance threshold) measured by the position probe 230 or, in other words, a target position of the male rotor 94 and/or the female rotor 95 within the rotor portion 86. For example, when the separation distance measured by the position probe 230 exceeds the target separation distance by a threshold amount, the resultant force 116 (e.g., the thrust load imposed on the thrust bearing 110) may be determined to exceed the predetermined thrust load.

Similar to the target separation distance, the predetermined thrust load may be associated with a target range of axial deflection of the thrust bearing 110. For example, if an axial deflection of the thrust bearing 110 deviates from the target range by a predetermined value, the resultant force 116 may be determined to exceed the predetermined thrust load. In some embodiments, the second position probe 234 may be used to measure a position of the inner ring and/or a position of the outer ring of the thrust bearing 110. When a position of the inner ring and/or the outer ring deviates from a target position by a predetermined amount, it may be determined that the resultant force 116 deviates from the predetermined thrust load. Further, the controller 186 may determine displacement of the inner ring with respect to the outer ring based on a rate of change (e.g., the derivative) of a function associated with displacement. As such, the rate of change of the displacement may be utilized to adjust the regulating force 114.

As discussed above, the second position probe 234 may be configured to provide feedback indicative of a contact angle of a ball of the thrust bearing 110. As such, when the contact angle of the ball of the thrust bearing 110 deviates from a target contact angle by a threshold, it may be determined that the resultant force 116 deviates from the predetermined thrust load. In still further embodiments, another suitable sensing device may be configured to monitor a parameter indicative of load applied to the thrust bearing 110, which may correspond to axial deflection of one or more portions of the thrust bearing 110. For example, the controller 186 may include instructions configured to calculate the load applied to the thrust bearing 110 via feedback from one or more sensors. In other embodiments, the controller 186 may be communicatively coupled to a network that enables the controller 186 to send the feedback from the one or more sensors to an external computing device that may calculate the load applied to the thrust bearing 110. The controller 186 may then receive and/or store the load applied to the thrust bearing 110 to adjust the regulating force 114. Additionally or alternatively, the controller 186 (or the external computing device) may calculate the load applied to the thrust bearing 110 via a look up table that correlates the feedback from the one or more sensors to the load applied to the thrust bearing 110.

When the axial deflection of one or more portions of the thrust bearing 110 deviate from a target axial deflection by a threshold, it may be determined that the resultant force 116 deviates from the predetermined thrust load. The controller 186 may be communicatively coupled to the position probe 230 and/or the second position probe 234, and use the measurements acquired by the position probe 230 and/or the second position probe 234 as feedback to adjust the regulating force 114 applied by the balance piston 112. In some embodiments, the controller 186 may thus maintain an optimized oil film between the second end portion 106 of the male rotor 94 and the inner surface 232 of the discharge portion 88.

Accordingly, a target operational life (e.g., an effective operational life) of the thrust bearing 110 may correspond to the target separation distance between the second end portion 106 of the male rotor 94 and the inner surface 232 of the discharge portion 88 or, in other words, the target position of the male rotor 94 within the rotor portion 86. The length of the target separation distance may be determined experimentally, similar to the iterative tests disclosed above with respect to FIG. 4.

FIG. 5 is an embodiment of a method 240 that may be used to increase the operational life of the thrust bearing 110 via measurements acquired by the position probe 230 and/or the second position probe 234. For example, at block 242, the controller 186 may measure a length of the separation distance between the second end portion 106 of the male rotor 94 and/or the female rotor 95 and an inner surface 232 of the discharge portion 88 during operation of the compressor 32 or, in other words, determine a position of the male rotor 94 and/or the female rotor 95 within the rotor portion 86. At block 244, the controller 186 may be configured to instruct the valve 180 to adjust the pressure within the first chamber 164 of the balance piston 112 when a length of the separation distance increases above or decreases below the target separation distance by a threshold value. As discussed above, increasing or decreasing the pressure within the first chamber 164 may increase or decrease the magnitude of the regulating force 114, respectively. The magnitude of the resultant force 116 may decrease when the regulating force 114 increases, such that the male rotor 94 may axially slide toward the compressor outlet 33 (e.g., in the direction 115). Conversely, when the regulating force 114 decreases, the magnitude of the resultant force 116 may increase, such the male rotor 94 may translate axially toward the compressor inlet 31.

As discussed above, the bearing load control system 72 may use any other suitable force application device to adjust the regulating force 114 in addition to, or in lieu of, the balance piston 112. For example, the controller 186 may be used to control a magnetic bearing disposed about the shaft 102 of the male rotor 94 to adjust an axial force (e.g., the regulating force 114) applied to the shaft 102 and/or the thrust bearing 110. As such, the controller 186 may use the magnetic bearing to adjust the regulating force 114 when the length of the separation distance (e.g., the position of the male rotor 94 and/or the position of the female rotor 95) deviates from the target separation distance (e.g., the target position) be a threshold amount.

At block 246, the position probe 230 may continuously monitor the length of separation distance while the valve 180 adjusts the pressure within the first chamber 164. Similarly, the second position probe 234 may monitor an axial deflection of the thrust bearing 110. At block 248, when the controller 186 determines that the length of the separation distance is substantially close to the threshold length, the controller 186 may instruct the valve 180 to maintain the current pressure differential between the first chamber 164 and the second chamber 166, and thus, the magnitude of the regulating force 114. The controller 186 may continuously monitor the length of the separation distance, and adjust the regulating force 114 applied by the balance piston 112 when the length of the gap deviates from the threshold length. In certain embodiments, the controller 186 may adjust the regulating force 114 when the axial deflection of the thrust bearing 110 exceeds the target range by the predetermined value. For example, if a position of the inner ring and/or a position of the outer ring of the thrust bearing 110 deviates from a target position by a threshold amount, the controller 186 may instruct balance piston 112 (or any other suitable force application device) to adjust a magnitude of the regulating force 114. Conversely, the controller 186 may instruct the valve 180 to maintain the current pressure differential between the first and second chambers 164, 166 when the axial deflection is within the target range. As discussed above, the method 240 may be used in addition to, or in lieu of, the method 210, in order to facilitate enhancing the operational life of the thrust bearing 110.

It should be noted that embodiments of the bearing load control system 72 disclosed herein may apply to screw compressors having rotors that are disposed side-by-side, in addition to, or in lieu of, rotors that are disposed above-and-below one another. It should be understood by those of ordinary skill in the art that the embodiments of the bearing load control system 72 disclosed herein may be used in any suitable compressor or system that utilizes a compressor. For example, the bearing load control system may be included in air compressors that supply pressurized air to pneumatic devices, such as tools, compressors included in a supercharger for a car engine, and/or compressors utilized in airplanes, boats, and/or other suitable applications.

While only certain features and embodiments have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described (i.e., those unrelated to the presently contemplated best mode, or those unrelated to enablement). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A bearing load control system, comprising:
a force application device configured to apply a force to a bearing of a compressor;
a sensor configured to provide feedback indicative of an operating parameter of the compressor; and
a controller, wherein the controller is communicatively coupled to the sensor and configured to determine an indication of a thrust force applied to the bearing based on the feedback indicative of the operating parameter, wherein the controller is configured to adjust the force application device to control the force applied to the bearing based at least in part on a control algorithm and the indication of the thrust force.

2. The bearing load control system of claim 1, wherein the controller is configured to adjust the force application device to control the force, such that a resultant force applied to the bearing is within a threshold range of a target bearing load.

3. The bearing load control system of claim 1, wherein the force and the thrust force are applied in a same direction with respect to a central axis of the compressor or applied in substantially opposite directions with respect to the central axis of the compressor.

4. The bearing load control system of claim 1, wherein the sensor is configured to provide additional feedback indicative of a plurality of operating parameters, and wherein the plurality of operating parameters comprises at least two of a suction pressure of the compressor, a discharge pressure of the compressor, a slide valve position of the compressor, a slide stop position of the compressor, and/or a pressure of refrigerant in an economizer.

5. The bearing load control system of claim 1, wherein the force application device comprises a balance piston configured to be controlled by a pressurized fluid.

6. The bearing load control system of claim 5, further comprising:
a piston fluid sensor configured to measure a pressure of the pressurized fluid supplied to the balance piston; and
a pressure control device disposed upstream of the piston fluid sensor with respect to a flow of the pressurized fluid, wherein the controller is communicatively coupled to the piston fluid sensor and the pressure control device, the controller is configured to adjust the pressure control device to control the pressure of the pressurized fluid based on feedback from the piston fluid sensor, and the pressure of the pressurized fluid is indicative of the force.

7. The bearing load control system of claim 6, wherein the pressure control device is a step-less pressure control valve.

8. The bearing load control system of claim 1, wherein the force application device comprises a magnetic bearing.

9. The bearing load control system of claim 1, wherein the sensor comprises a position probe that is configured to provide feedback indicative of a position of a rotor of the compressor with respect to a housing of the compressor.

10. The bearing load control system of claim 9, wherein the controller is configured to adjust the force application device to control the force when the position of the rotor deviates from a target position by a threshold amount.

11. A bearing load control system for a compressor, comprising:
a force application device disposed within a housing of the compressor, wherein the force application device is configured to apply a force to a shaft of the compressor;
a sensor configured to provide feedback indicative of an operational parameter of the compressor; and
a controller communicatively coupled to the sensor, wherein the controller is configured to determine an indication of a thrust force applied to a bearing that is rotatably coupled the shaft based on feedback from the sensor, and wherein the controller is configured to control the force applied by the force application device based at least in part on a control algorithm, such that a resultant force applied to the bearing is within a threshold range of a target bearing load.

12. The bearing load control system of claim 11, wherein the force application device comprises a balance piston configured to be actuated by a pressurized fluid, wherein a pressure control device is configured to regulate a pressure of the pressurized fluid supplied to the balance piston.

13. The bearing load control system of claim 12, wherein the controller is communicatively coupled to the pressure control device, and the controller is configured to adjust the pressure control device to control the pressure of the pressurized fluid when the resultant force deviates from the target bearing load by a set amount.

14. The bearing load control system of claim 11, wherein the operational parameter comprises a suction pressure of the compressor, a discharge pressure of the compressor, a slide valve position of the compressor, and a slide stop position of the compressor.

15. The bearing load control system of claim 11, wherein the sensor comprises a position probe configured to monitor a position of the compressor shaft with respect to the housing.

16. The bearing load control system of claim 15, wherein the controller is configured to adjust the force application device to control the force when the position of the compressor shaft deviates from a target position by a set amount.

17. A method of operating a bearing load control system of a compressor, comprising:
acquiring feedback indicative of an operational parameter of the compressor using a sensor;
monitoring a thrust force applied to a bearing of the compressor based on the feedback from the sensor; and
actuating a force application device to apply a force to the bearing based on the thrust force.

18. The method of claim 17, comprising adjusting the force such that a resultant force applied to the bearing is within a threshold range of a target bearing load, wherein the force is determined based at least in part on a control algorithm, and wherein the resultant force is the sum of the force and the thrust force.

19. The method of claim 17, wherein the sensor comprises a plurality of sensors, wherein acquiring the feedback indicative of the operational parameter of the compressor using the sensor comprises acquiring feedback indicative of a plurality of operational parameters of the compressor using the plurality of sensors, and wherein acquiring the feedback indicative of the plurality of operational parameters comprises:
measuring, via a first sensor of the plurality of sensors, a suction pressure of the compressor at an inlet of the compressor; and
measuring, via a second sensor of the plurality of sensors, a discharge pressure of the compressor at an outlet of the compressor.

20. The method of claim 19, wherein acquiring the feedback indicative of the plurality of operational parameters further comprises:
measuring, via a third sensor of the plurality of sensors, a position of a slide valve of the compressor; and
measuring, via a fourth sensor of the plurality of sensors, a position of a valve body of the compressor.

21. The method of claim 17, wherein acquiring the feedback indicative of the operational parameter of the compressor using the sensor comprises acquiring the feedback indicative of a position of a rotor of the compressor using a position probe, and further comprising:
comparing the position of the rotor to a target position using a controller; and
adjusting the force when a first difference between the position and the target position exceeds a first threshold amount.

22. The method of claim 21, wherein the target position is indicative of a target bearing load on the bearing.

23. The method of claim 22, comprising monitoring a first ring position of an inner ring of the bearing and monitoring a second ring position of an outer ring of the bearing and adjusting the force when a second difference between the first ring position and the second ring position deviates from a target value by a second threshold amount.
